(19) United States
(12) Patent Application Publication
(10) Pub. No.: US 2007/0222391 A1
(43) Pub. Date: Sep. 27, 2007

(54) CURRENT BALANCING CIRCUIT FOR LIGHT EMITTING DIODES

(75) Inventors: Li-Min Lee, Taipei (TW); Che-Nan Tien, Taipei (TW); Chung-Che Yu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BEYOND INNOVATION TECHNOLOGY CO., LTD., Taipei (TW)

(21) Appl. No.: 11/609,576

(22) Filed: Dec. 12, 2006

(30) Foreign Application Priority Data
Mar. 24, 2006 (TW) 95110236

(51) Int. Cl. B60Q 1/02

(52) U.S. Cl. 315/82

(57) ABSTRACT

The invention provides an LED current balancing circuit, comprising a first and a second LED set coupled to a voltage source, a first transistor, and a second transistor. The first LED set comprises a first loader. The first transistor and the second transistor form a current balancing circuit for adjusting currents passing through the first and second LED sets.

### BACKGROUND OF THE INVENTION

1. Field of the Invention

The invention relates to a current balancing circuit, and more particularly to a current balancing circuit reducing the voltage difference between two input terminals of a current mirror for preventing current mirror ineffectiveness.

2. Description of the Related Art

Before shipping, light emitting diodes (LEDs) are tested and classified according to the threshold voltage, such as 3.2V, 3.4V and 3.6V. Due to the inaccuracies in measuring the threshold voltage of LEDs, the voltage for driving LEDs may be not enough. For example, if an LED set has 10 LEDs with 3.2V threshold voltage on one side of the driving circuit, and another LED set has 10 LEDs with 3.6V threshold voltage on another side of the driving circuit, a voltage difference of 4V is thus generated, and the driving circuit may not drive the LED set with 3.6V LEDs. FIG. 1A is a circuit diagram of a conventional LED driving circuit. In FIG. 1, a resistor R is applied to detect and feedback control the total current of LEDs. To make the current passing I₁ through the LED set 10 equal to the current I₂ passing through the LED set 12, a current mirror comprising transistors T11 and T12 is applied. However, voltage drops generated when the current I₁ or I₂ passing the diodes of LED set 10 or LED set 12, such as diode 11, are not the same. When the voltage level of the node 13 exceeds the voltage level of node 14, transistor T12 can not be activated. FIG. 1B is a circuit diagram of another conventional driving circuit for LEDs. Compared with the circuit of FIG. 1A, the circuit of FIG. 1B does not use the resistor R for feedback controlling.

FIG. 2 is a circuit diagram of a conventional current balancing circuit for reducing the probability of current mirror failure. In FIG. 2, resistors Rf1 and Rf2 are used to adjust the base voltage of the bases of transistors T21 and T22 to make sure the currents I₁ and I₂ are substantially equal. Thus, a current balancing circuit capable of reducing the voltage difference between the node 21 and node 22 is desirable.

### BRIEF SUMMARY OF THE INVENTION

The invention provides a current balancing circuit for LEDs, comprising a first transistor, a second transistor, a resistor, a first LED set, a second LED set and a loader. The first transistor has a control terminal coupled to a first input terminal, and a first output terminal coupled to the resistor. The second transistor has a second control terminal coupled to the first control terminal, a second input terminal and a second output terminal coupled to the resistor. The resistor has two terminals, wherein one terminal is coupled to the first output terminal and the second output terminal, and another terminal is coupled to ground. The second LED set is coupled to the high voltage source and the second input terminal. The first LED set is coupled to the high voltage source and the loader or the second LED set is coupled to the high voltage source and the loader, wherein the voltage level of the first input terminal is approximately equal to or higher than the voltage level of the second input terminal by adjusting the equivalent resistance of the loader.

The invention provides a current balancing circuit comprising a first transistor, a second transistor, a first LED set having n LEDs, and a second LED set having m LEDs. The first transistor has a first control terminal, a first input terminal and a first output terminal, wherein the first input terminal is coupled to the first control terminal. The second transistor has a second control terminal, a second input terminal and a second output terminal, wherein the second control terminal is coupled to the first control terminal and the second output terminal is coupled to the first output terminal. The first LED set is coupled to a voltage source and the first input terminal. The second LED set is coupled to the voltage source and the second input terminal, wherein m is not equal to n and the voltage level of the second input terminal is substantially equal to or more than the voltage level of the first input terminal.

The invention provides a current balancing circuit comprising a first and a second LED set coupled to a voltage source, a first loader coupled to the first LED set, a first transistor and a second transistor. The first transistor has a first control terminal, a first input terminal and a first output terminal, wherein the first loader is coupled between the first input terminal and the first LED. The second transistor has a second control terminal, a second input terminal and a second output terminal, wherein the second control terminal is coupled to the first control terminal, the second output terminal is coupled to the first output terminal, and the voltage level of the second input terminal is substantially equal to or more than the voltage level of the first input terminal.

The invention provides a current balancing circuit comprising a current equalization circuit, a first LED set, and a second LED set. The current equalization circuit has a first input terminal, a second input terminal and an output terminal, wherein the first input terminal is controlled by a control voltage. The first LED set is coupled between a voltage source and the first input terminal. The second LED set is coupled between the voltage source and the second input terminal, wherein a voltage level of the second input terminal is substantially equal to a voltage level of the first input terminal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a circuit diagram of a conventional LED driving circuit.

FIG. 1B is a circuit diagram of another conventional LED driving circuit.

FIG. 2 is a circuit diagram of a convention current balancing circuit reducing the probability of failure of current mirror.

FIG. 3A is a schematic diagram of an embodiment of an LED current balancing circuit of the invention.

FIG. 3B is another schematic diagram of an embodiment of an LED current balancing circuit of the invention.

FIG. 3C another schematic diagram of an embodiment of an LED current balancing circuit of the invention.

FIG. 3D are another schematic diagrams of an embodiments of an LED current balancing circuit of the invention with an additional ballasting resistor.

FIG. 4 is a schematic diagram of another embodiment of the current balancing circuit of the invention.

FIG. 5 is a schematic diagram of another embodiment of current balancing circuit of the invention.

FIG. 6A-6F are schematic diagrams of embodiments of current balancing circuit with three LED sets of the invention.

FIG. 7 is a schematic diagram of another embodiment of current balancing circuit with three LED sets of the invention.

FIG. 8 is a schematic diagram of another embodiment of current balancing circuit with three LED sets of the invention.

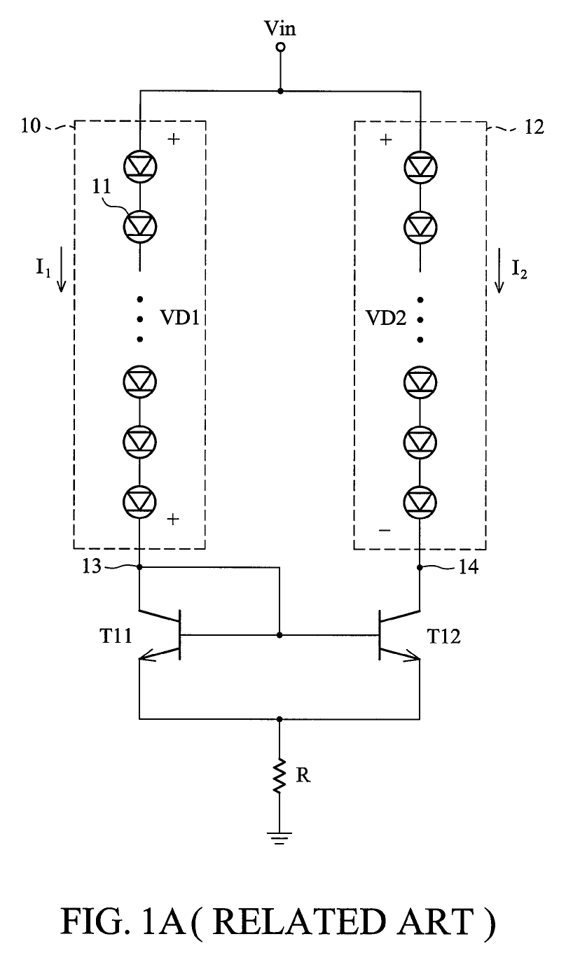

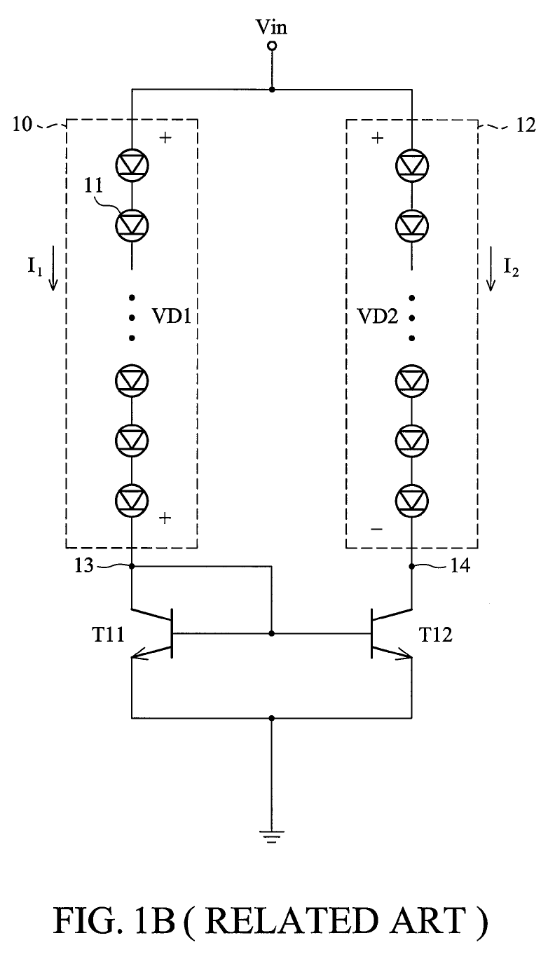

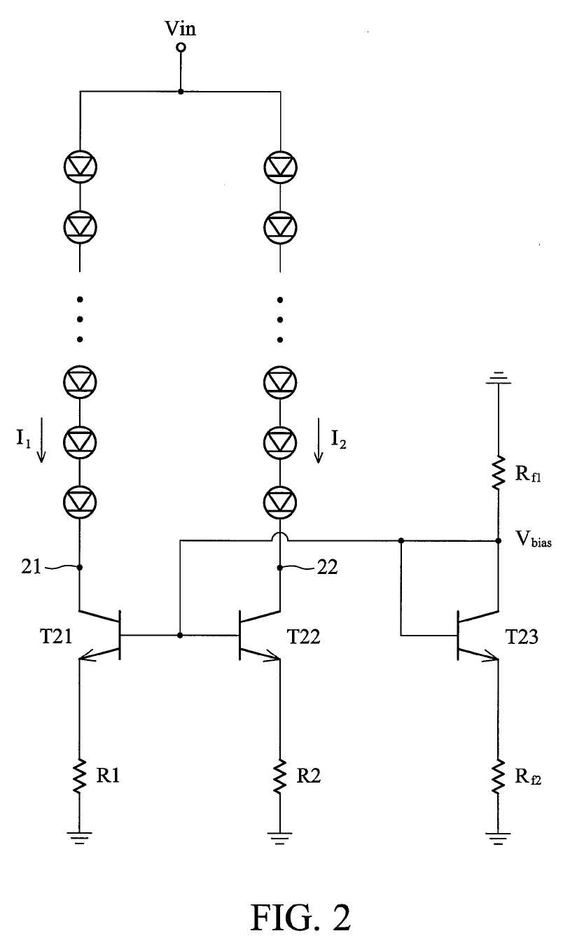

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The principle of the invention is adjusting the number of LEDs or the arrangement of two LED sets according to the threshold voltages of the LEDs to ensure correct operation of the current balancing circuit. Furthermore, a loader is applied to reduce the voltage difference between the two LED sets to make the voltage level of each terminal of the transistor of the current balancing circuit relatively equal, such as a collector, a base and an emitter of a BJT, and a source, drain, and a gate of MOS, thus, the performance of the current balancing circuit increases.

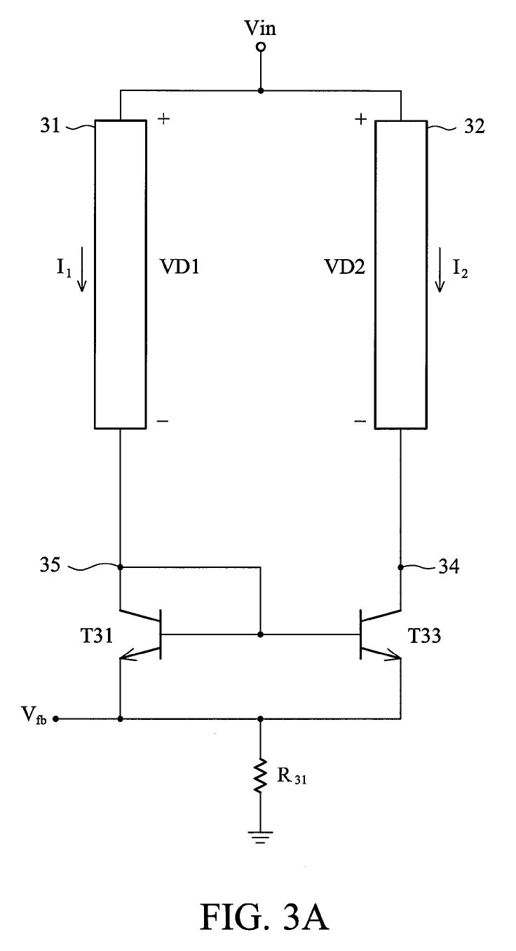

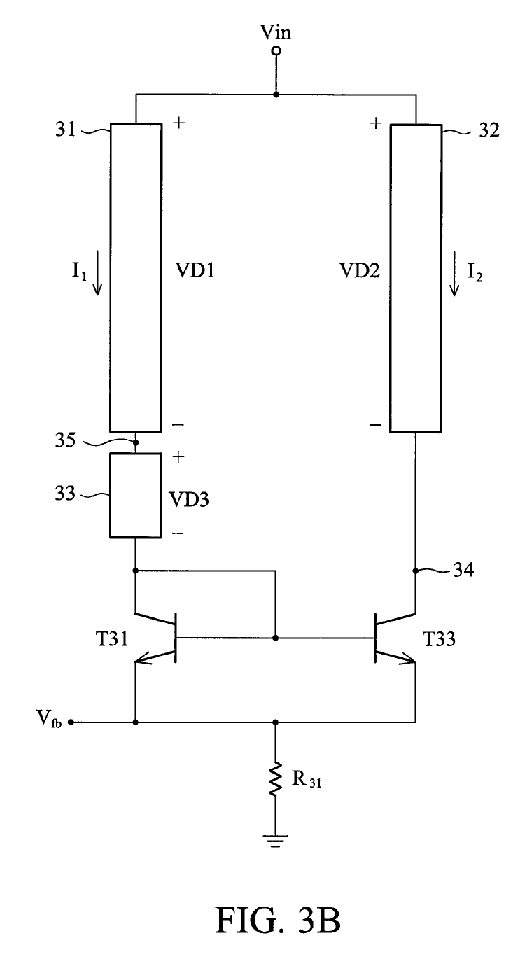

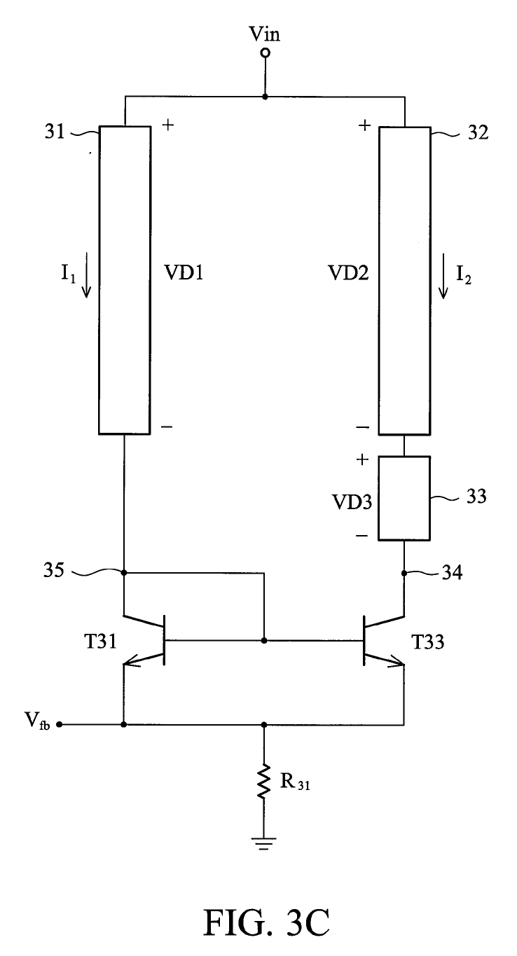

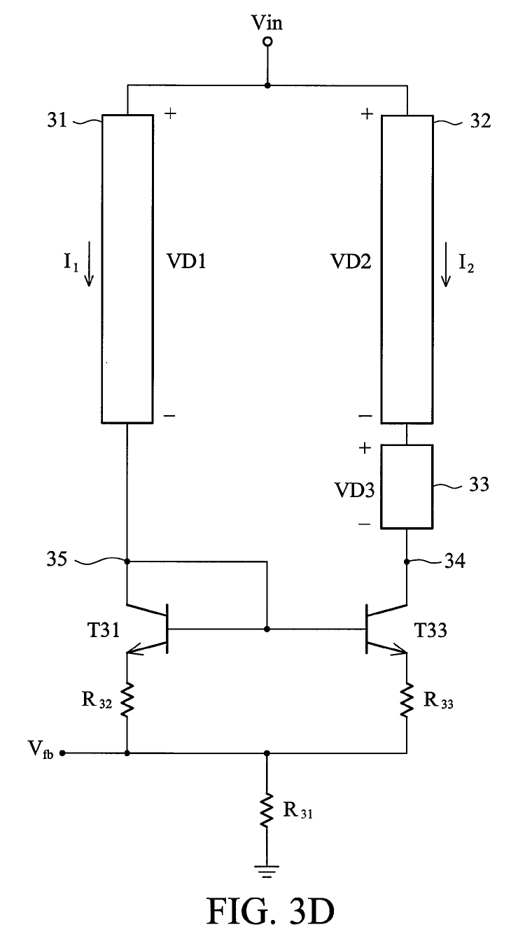

FIG. 3A is a schematic diagram of an embodiment of a current balancing circuit for LEDs of the invention. A terminal of an LED set 32 is coupled to voltage Vin and another terminal 34 is coupled to the collector of transistor T33. An LED set 31 is coupled between the voltage Vin and the collector 35 of transistor T31. A base of transistor T33 is coupled to a base of transistor T31 and the collector of transistor T31. An emitter of transistor T31 and an emitter of transistor T33 are coupled to resistor R31. In the following description, the LED set 31 coupled by the transistor T31 is called as primary LED set, and another LED set is called a secondary LED set, wherein the primary LED set and the secondary LED set comprises at least one LED. When a current I₁ passes through the primary LED set 31, a voltage drop VD1 is generated, and when a current I₂ passes through the secondary LED set 32, a voltage VD2 is generated. In this embodiment, the VD1 is substantially equal to or more than VD2. To achieve that, the LEDs of the primary LED set have a higher threshold than the LEDs of the secondary LED set, or the number of LEDs of the primary LED set 31 is not equal to the number of the LEDs of the secondary LED set 32, wherein the voltage drop VD1 of the primary LED set 31 is more than the voltage VD2 of the secondary LED set 32. When the VD1 is more than VD2, the voltage level of the collector of transistor T31 is substantially equal to or less than the voltage level of the collector of transistor T33, thus, the transistor T33 is in the saturation region and the probability that the transistor T33 cannot be driven due to the low voltage of node 34 is reduced. In this embodiment, transistor T31 and T33 are bipolar junction transistors (BJT) or MOS transistors.

In the circuit of FIG. 3A, the luminance of the LEDs is determined by the total current passing through the primary and secondary LED set 31 and 32, determined by a feedback control signal, V_{fb}.

In the circuit of FIG. 3A, the emitters of transistors T31 and T33 can be directly grounded if the circuit does not require a feedback control signal to control the luminance of the LEDs.

FIG. 3B is another schematic diagram of an embodiment of a current balancing circuit for LEDs of the invention. The difference between the embodiments of FIG. 3A and 3B is a loader 33 coupled between the node 35 of the primary LED set 31 and the collector of transistor T31, i.e., the primary LED set 31 comprises the loader 33. In this embodiment, the voltage level of the collector of transistor T31 is substantially equal to or less than the voltage level of the collector of transistor T33 by the loader 33 even if the voltage drop VD1 of the primary LED set 31 is less than the voltage VD2 of the secondary LED set 32, thus, the transistor T33 is in the saturation region. Furthermore, the base of transistor T31 can also be coupled to node 35, not the collector of transistor T31 shown in FIG. 3A, thus, the voltage level of the collector of transistor T31 can also be substantially equal to or less than the voltage level of the collector of transistor T33.

In this embodiment, the loader 33 is a resistor, a diode, a LED, a variable resistor or the combination thereof. The variable resistor may be a voltage-controlled resistor formed by a transistor, wherein the resistance is determined by the voltage of the base or gate of the transistor.

FIG. 3C is another schematic diagram of an embodiment of a current balancing circuit for LEDs of the invention. In the circuit of FIG. 3C, the loader 33 is connected in serial with the secondary LED set 32 to reduce the voltage difference between the nodes 34 and 35, i.e., VD1 is substantially equal to a slightly greater voltage than the sum of VD2 and VD3, thus, the current passing through the primary LED set 31 is substantially equal to the current passing through the secondary LED set 32 to ensure the stable operation of the circuit of FIG. 3C.

Furthermore, except for the loader for reducing the failure of the current balancing circuit of the invention due to the threshold voltage of the LEDs. Further, ballasting resistors R₃₂ and R₃₃ coupled to the emitters of transistors T31 and T33 are applied to balance the currents passing through the primary LED set 31 and the secondary LED set 32 to achieve better current balancing performance, as FIG. 3D.

Before shipping, light emitting diodes (LEDs) are tested and classified according to the threshold voltage, such as 3.2V, 3.4V and 3.6V. The described embodiments are suited to both the classified and non-classified LEDs. If the primary LED set has x LEDs with threshold voltage of 3.2V and the secondary LED set has x LEDs with threshold voltage of 3.6V, thus, the voltage difference between the primary LED set and the secondary set is 0.4x V. Thus, one skilled in the art can simply adjust the voltage difference by adjusting the number or type, such as 3.2V, 3.4V and 3.6V, of LEDs in the primary LED set and the secondary LED set.

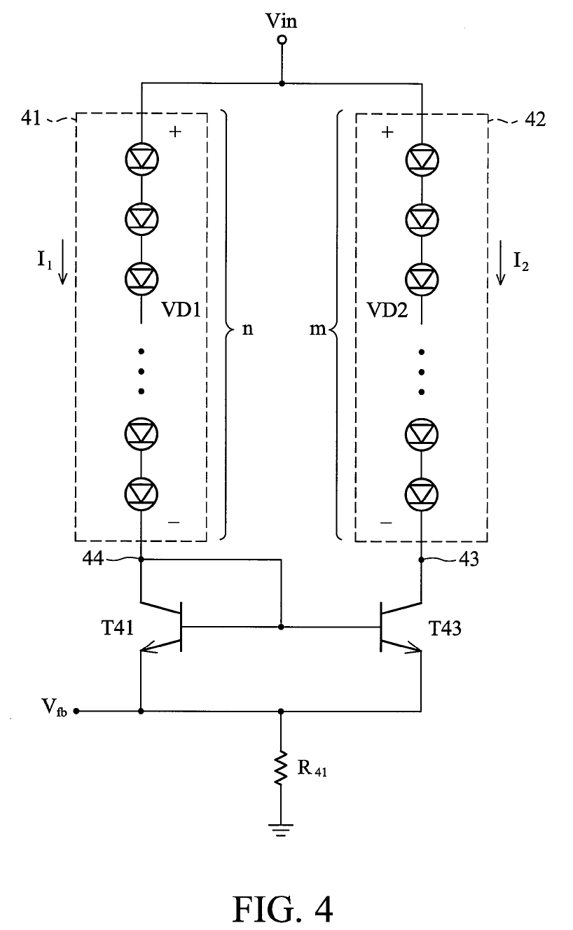

In embodiment of the current balancing circuit, LEDs with a lower threshold voltage are included in the secondary LED set 42. A base of a BJT T41 is coupled to a collector of the BJT T41. Please refer to FIG. 4. FIG. 4 is a schematic diagram of another embodiment of the current balancing circuit of the invention. In FIG. 4, the number of the LEDs of the primary LED set 41 is equal to the number of LEDs of the secondary LED set 42, i.e., n=m. Due to the lower threshold voltage of LEDs in the primary LED set 41, the voltage level of the collector of transistor T43, i.e., node 43, is higher than the voltage level of the collector of the transistor T41 (node 44), i.e., the voltage level of the base of the transistor T41, thus, the transistor T43 can operate normally and the collector currents of transistors T41 and T43 are substantially the same.

In another embodiment of the current balancing circuit, wherein the number of LEDs of the primary LED set is not equal to the number of LEDs of the secondary LED set, i.e., n≠m. In FIG. 4, the threshold voltage of the LEDs in the primary LED set 41 is less than the threshold of the LEDs in the secondary LED set 42. To keep the voltage level of node 44 larger than or equal to the voltage level of node 43, the number of LEDs in the secondary LED set 42 must be less than the number of LEDs in the primary LED set 41. For example, if the primary LED set 41 comprises n LEDs with threshold voltage 3.2V and the secondary LED set 42 comprises m LEDs with threshold voltage 3.6V, wherein n is 5 and m is 4. When the threshold voltage of the LEDs in the primary LED set 41 is larger than the threshold of the LEDs in the secondary LED set 42, the number of LEDs in the secondary LED set 42 must be more than the number of LEDs in the primary LED set 41 to reduce the voltage difference between the nodes 44 and 43. For example, if the primary LED set 41 comprises n LEDs with threshold voltage 3.6V and the secondary LED set 42 comprises m LEDs with threshold voltage 3.2V, wherein n is 10 and m is 11. In FIG. 4, the VD1 is substantially equal to or more than VD2 by adjusting the number of LEDs of the LED sets 41 and 42, thus, the transistor T43 is in a situation region. Furthermore, the luminance of the LED sets 41 and 42 can be adjusted by adjusting the Vfb. In this embodiment, the transistors are BJT and the circuit of the embodiment can also be implemented by MOS transistors. Moreover, a loader and a ballasting resistor can also be applied to the circuit for better performance.

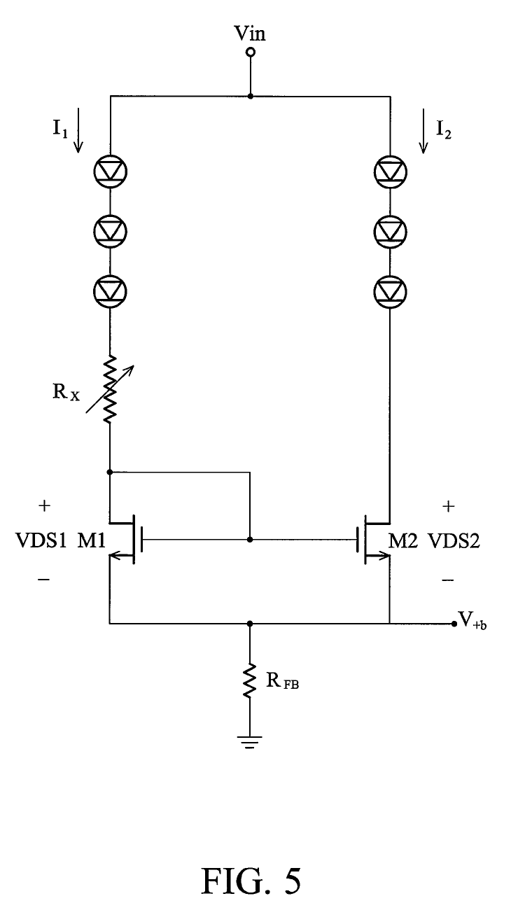

FIG. 5 is a schematic of another embodiment of a current balancing circuit of the invention, and in FIG. 5, the LEDs are classified LEDs. In FIG. 5, currents I₁ and I₂ can be acquired by the equation:

I=K*(V_{GS}−Vₜ)²*(1+λ V_{DS})

In this embodiment, the LEDs connected in serial by the variable resistor Rx have a threshold voltage 3.2V and the LEDs on another side have a threshold voltage 3.6V. Take three LEDs on both sides of the current balancing circuit as an example, the percentage of current difference between I₁ and I₂ is more than 20% without the variable resistor Rx, and percentage of the current difference between I₁ and I₂ is less than 1% with the variable resistor Rx. Furthermore, the variable resistor Rx can be serially connected to the transistor M2 of the circuit. Moreover, a loader and a ballasting resistor can also be applied to the circuit for better performance.

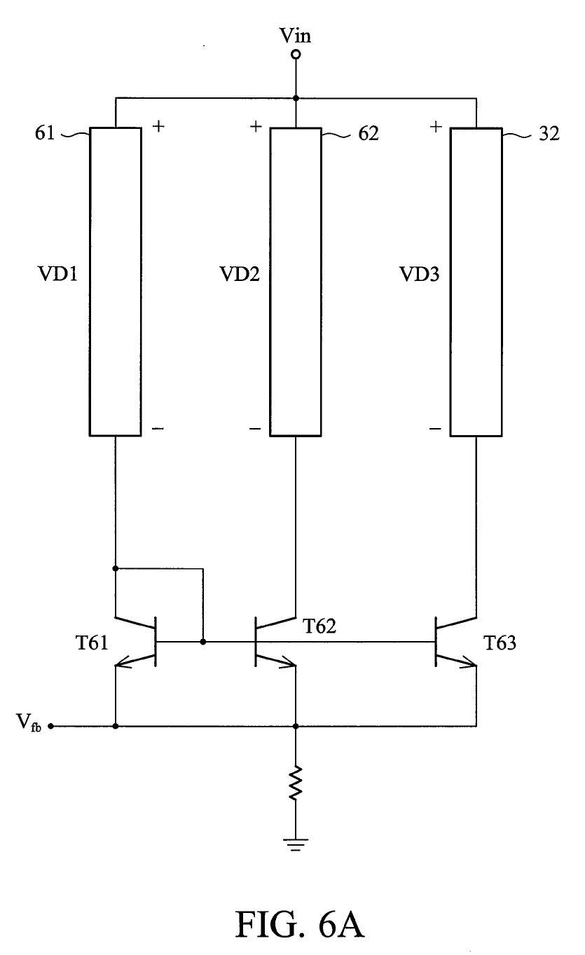

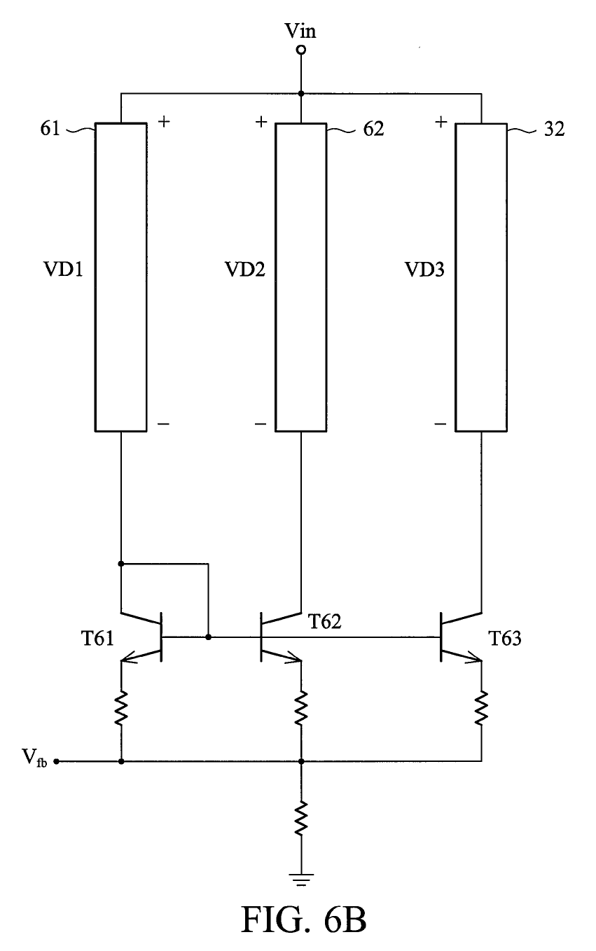

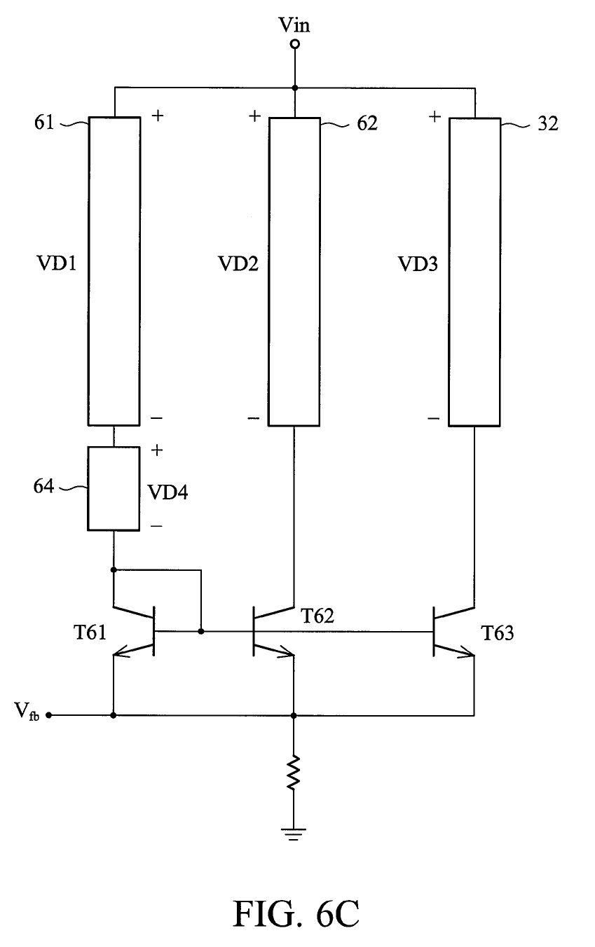

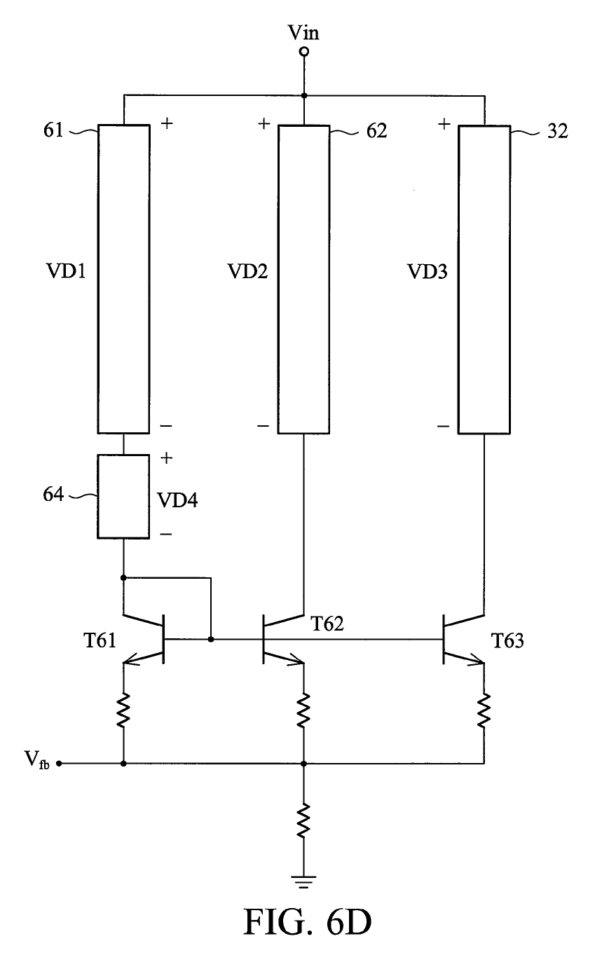

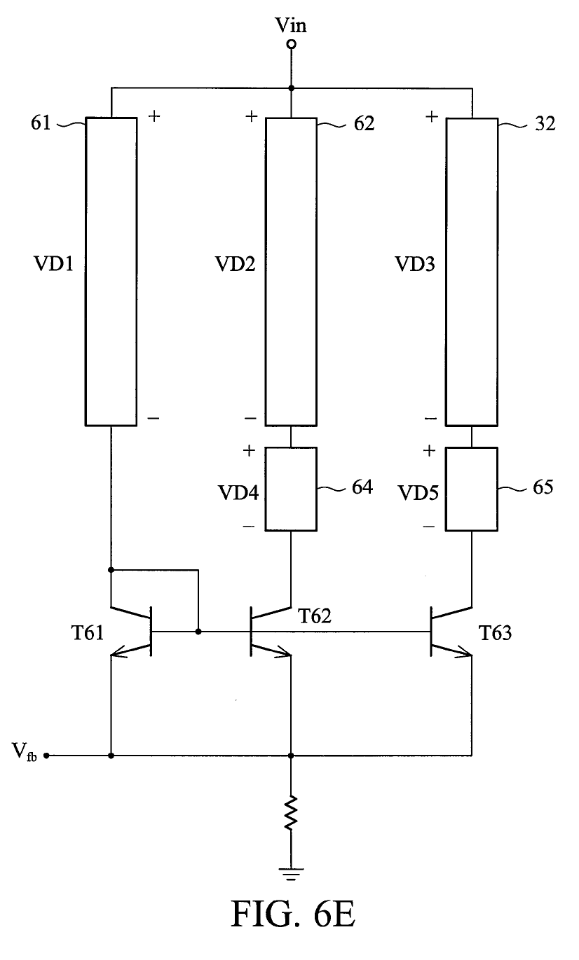

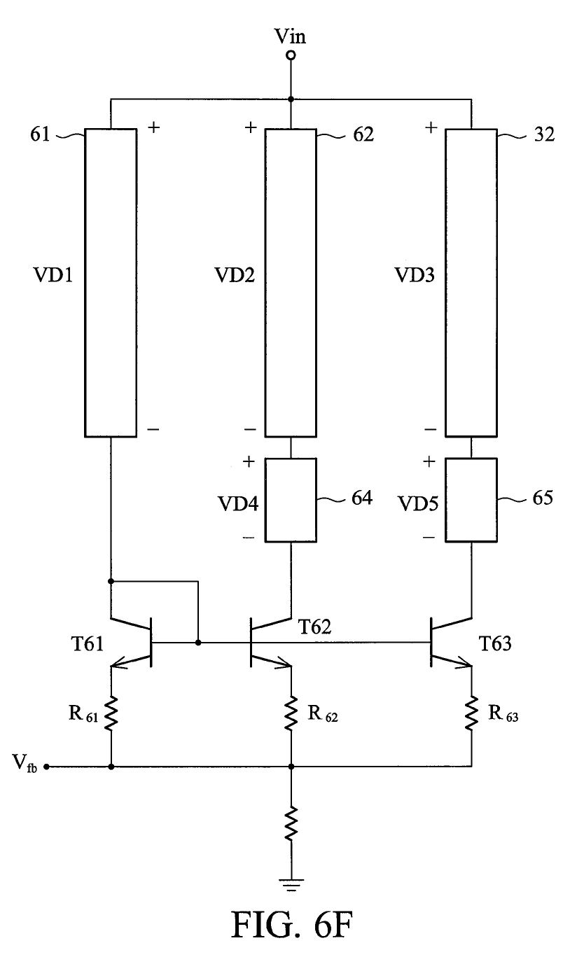

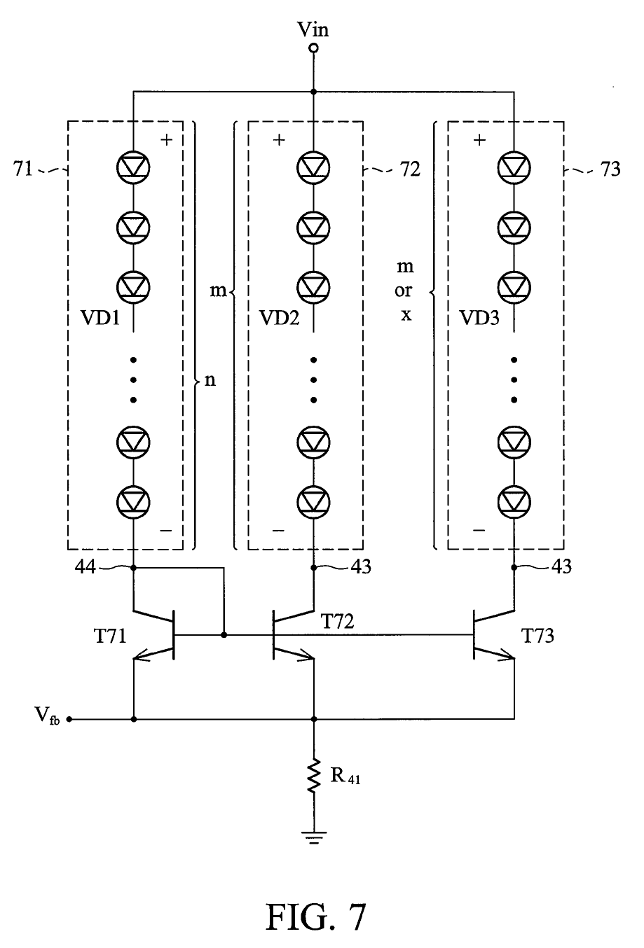

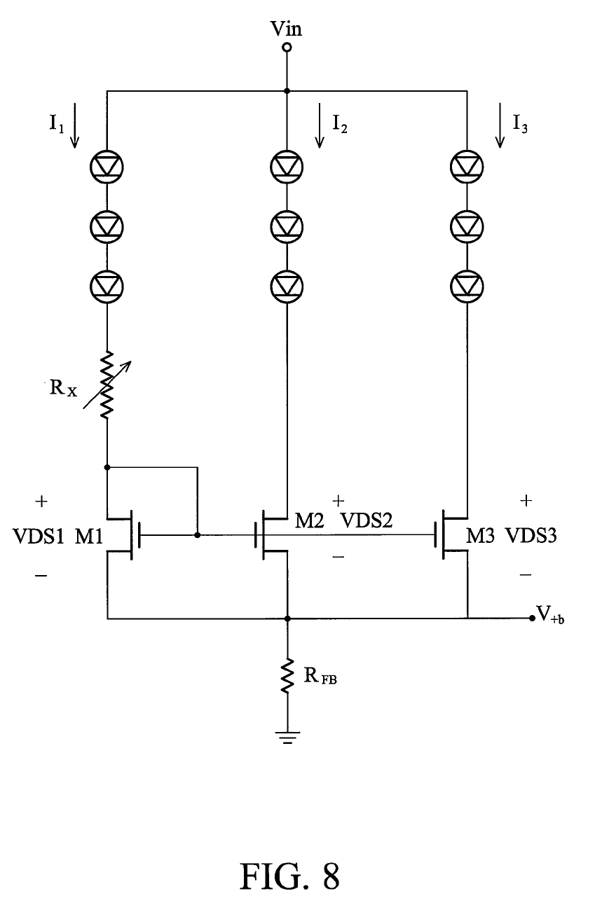

The described embodiments illustrate the invention with two LED sets; however three or more LED sets can also be employed for better current balancing performance. FIG. 6A, FIG. 6C, FIG. 6E, FIG. 7 and FIG. 8 are schematic diagrams with three LED sets of the current balancing circuits corresponding to FIG. 3A, FIG. 3B, FIG. 3C, FIG. 4 and FIG. 5. In FIG. 6A, VD1 is greater than VD2 or VD3. FIG. 6B is a current balancing circuit of FIG. 6A with an additional ballasting resistor. In FIG. 6C, VD1 is less than one of the VD2 and VD3, and one of the VD2 and VD3 is substantially less than or equal to the sum of the VD1 and VD4, a voltage drop of a loader 64. FIG. 6D is a current balancing circuit of FIG. 6C with an additional ballasting resistor. In FIG. 6E, VD1 is greater than VD2 and VD3. Add the loader 64 and 65 to ensure that VD1 substantially greater than or equal to the sum of VD2 and VD4 and the sum of VD3 and VD5. FIG. 6F is a current balancing circuit of FIG. 6E with additional ballasting resistors, R₆₁, R₆₂ and R₆₃. In FIG. 7 and FIG. 8, a voltage drop of the primary LED set and a loader serially connected thereto is substantially larger than or equal to a voltage drop of the second LED set and a loader serial connected thereto. The circuit shown in FIG. 7 or FIG. 8 is only illustration of one embodiment and is not intended to limit the invention. For brevity, description of like structures is omitted.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A current balancing circuit for LEDs, comprising:
a first LED set having a first loader, coupled to a voltage source;
a second LED set coupled to the voltage source;
a first transistor having a first control terminal, a first input terminal, a first output terminal, wherein the first input terminal is coupled to the first control terminal; and
a second transistor having a second control terminal, a second input terminal, a second output terminal, the second control terminal coupled to the first control terminal and the second output terminal coupled to the first output terminal, wherein the first LED set is coupled to the first input terminal or the second input terminal and the second LED set is coupled to the first input terminal or the second input terminal.

2. The circuit as claimed in claim 1, wherein a voltage level of the second input terminal is substantially equal to or more than a voltage level of the first input terminal.

3. The circuit as claimed in claim 1, wherein the first transistor and the second transistor are MOS transistors, the first input terminal and the second input terminal are drain terminals, and the first output terminal and the second output terminal are source terminals.

4. The circuit as claimed in claim 1, wherein the first transistor and the second transistor are bipolar junction transistors, the first input terminal and the second input terminal are collector terminals, and the first output terminal and the second output terminal are emitter terminals.

5. The circuit as claimed in claim 1, wherein the first loader is a resistor, a diode, a LED or the combination thereof.

6. The circuit as claimed in claim 1, wherein the first loader is an active resistor.

7. The circuit as claimed in claim 1, wherein the first loader is a voltage-controlled loader.

8. The circuit as claimed in claim 1, further comprising a feedback control unit coupled to the first input terminal to adjust a voltage of the voltage source.

9. The circuit as claimed in claim 1, wherein the average threshold voltage of the first LED set is less than the average threshold of the second LED set.

10. The circuit as claimed in claim 1, wherein the number of LEDs in the first LED set is equal to the number of LEDs in the second LED set.

11. The circuit as claimed in claim 1, further comprising a first resistor and a second resistor, wherein the first output terminal is coupled to the first resistor, the second output terminal is coupled to the second resistor, and the first resistor is coupled to the second resistor.

12. The circuit as claimed in claim 1, further comprising:
a third LED set having a second loader, coupled to the voltage source; and
a third transistor having a third control terminal, a third input terminal and a third output terminal, wherein the third control terminal is coupled to the first control terminal and the third output terminal is coupled to the first output terminal.

13. The circuit as claimed in claim 12, further comprising a first resistor, a second resistor and a third resistor, wherein the first output terminal is coupled to first resistor, the second output terminal is coupled to the second resistor, the third output terminal is coupled to the third resistor, and the first resistor is coupled to the second resistor and the third resistor.

14. A current balancing circuit for LEDs, comprising:
a first transistor having a first control terminal, a first input terminal and a first output terminal, wherein the first input terminal is coupled to the first control terminal;
a second transistor having a second control terminal, a second input terminal and a second output terminal, wherein the second control terminal is coupled to the first control terminal and the second output terminal is coupled to the first output terminal;
a first LED set having n LEDs, coupled to a voltage source and the first input terminal; and
a second LED set having m LEDs, coupled to the voltage source and the second input terminal, wherein m is not equal to n and the voltage level of the second input terminal is substantially equal to or more than the voltage level of the first input terminal.

15. The circuit as claimed in claim 14, wherein the first transistor and the second transistor are MOS transistors, the first input terminal and the second input terminal are drain terminals, and the first output terminal and the second output terminal are source terminals.

16. The circuit as claimed in claim 14, wherein the first transistor and the second transistor are bipolar junction transistors, the first input terminal and the second input terminal are collector terminals, and the first output terminal and the second output terminal are emitter terminals.

17. The circuit as claimed in claim 14, further comprising a feedback control unit coupled to the first output terminal to adjust an output voltage of the voltage source.

18. The circuit as claimed in claim 14, wherein the wherein the average threshold voltage of the first LED set is less than the average threshold of the second LED set.

19. The circuit as claimed in claim 14, wherein m=n−1.

20. The circuit as claimed in claim 14, wherein the first LED set or the second LED set has a loader.

21. The circuit as claimed in claim 20, wherein the loader is a resistor, an active resistor or a voltage-controlled loader.

22. The circuit as claimed in claim 14, further comprising a first resistor and a second resistor, wherein the first output terminal is coupled to the first resistor, the second output terminal is coupled to the second resistor, and the first resistor is coupled to the second resistor.

23. The circuit as claimed in claim 14, further comprising:
a third transistor having a third control terminal, a third input terminal and a third output terminal, wherein the third control terminal is coupled to the first control terminal and the third output terminal is coupled to the first output terminal; and
a third LED set having p LEDs, coupled to the voltage source and the third input terminal, wherein p is not equal to n, and the voltage level of the third input terminal is more than the voltage level of the first input terminal.

24. The circuit as claimed in claim 23, further comprising a first resistor, a second resistor and a third resistor, wherein the first output terminal is coupled to the first resistor, the second output terminal is coupled to the second resistor, the third output terminal is coupled to the third resistor, and first resistor is coupled to the second resistor and the third resistor.

25. A current balancing circuit for LEDs, comprising:
a first LED set coupled to a voltage source;
a first loader coupled to the first LED set;
a first transistor having a first control terminal, a first input terminal and a first output terminal, wherein the first loader is coupled between the first input terminal and the first LED;
a second LED set coupled to the voltage source; and
a second transistor having a second control terminal, a second input terminal and a second output terminal, wherein the second control terminal is coupled to the first control terminal, the second output terminal is coupled to the first output terminal, and the voltage level of the second input terminal is substantially equal to or more than the voltage level of the first input terminal.

26. The circuit as claimed in claim 25, wherein the first transistor and the second transistor are MOS transistors, the first input terminal and the second input terminal are drain terminals, and the first output terminal and the second output terminal are source terminals.

27. The circuit as claimed in claim 25, wherein the first transistor and the second transistor are bipolar junction transistors, the first input terminal and the second input terminal are collector terminals, and the first output terminal and the second output terminal are emitter terminals.

28. The circuit as claimed in claim 25, wherein the first loader is a resistor, a diode, an LED, an active resistor, a voltage-controlled loader or the combination thereof.

29. The circuit as claimed in claim 25, further comprising a first resistor and a second resistor, wherein the first output terminal is coupled to the first resistor, the second output terminal is coupled to the second resistor, and the first resistor is coupled to the second resistor.

30. The circuit as claimed in claim 25, further comprising:
a third LED set coupled to the voltage source;
a second loader coupled to the third LED set; and
a third transistor having a third control terminal, a third input terminal and a third output terminal, wherein the third input terminal is coupled between the second loader and the third LED set, and a voltage level of the third input terminal is substantially equal to the voltage level of the first input terminal.

31. The circuit as claimed in claim 30, further comprising a first resistor, a second resister and a third resistor, wherein the first output terminal is coupled to the first resistor, the second output terminal is coupled to the second resistor, the third output terminal is coupled to the third resistor, and the first resistor is coupled to the second resistor and the third resistor.

32. A current balancing circuit for LEDs, comprising:
a current equalization circuit having a first input terminal, a second input terminal and a output terminal, wherein the first input terminal is controlled by a control voltage;
a first LED set coupled between a voltage source and the first input terminal; and
a second LED set coupled between the voltage source and the second input terminal, wherein a voltage level of the second input terminal is substantially equal to or more than a voltage level of the first input terminal.

33. The circuit as claimed in claim 32, wherein the first LED set has a loader.

34. The circuit as claimed in claim 33, wherein the first loader is a resistor, a diode, an LED, an active resistor, a voltage-controlled loader or the combination thereof.

35. The circuit as claimed in claim 32, wherein an average threshold voltage of the first LED set is less than an average threshold of the second LED set.

36. The circuit as claimed in claim 32, wherein a threshold voltage of anyone LED of the first LED set is less than a threshold voltage of anyone LED of the second LED set.

37. The circuit as claimed in claim 35, wherein a number of LEDs in the first LED set is equal to a number of LEDs in the second LED set.

38. The circuit as claimed in claim 32, wherein an average threshold voltage of the first LED set is more than an average threshold of the second LED set, and a number of the first LED set is less than a number of the second LED set.

39. The circuit as claimed in claim 32, further comprising a third LED set and the current equalization circuit further comprising a third input terminal, wherein the third LED set is coupled between the voltage source and the third input terminal, and a voltage level of the third input terminal is substantially equal to or more than a voltage level of the first input terminal.
